(19) United States
(12) Patent Application Publication
(10) Pub. No.: US 2007/0028266 A1
(43) Pub. Date: Feb. 1, 2007

(54) Recommendation of video content based on the user profile of users with similar viewing habits

(75) Inventors: Miroslav Trajkovic, Ossining, NY (US); Srinivas Gutta, Bangalore (IN); Vassanth Philomin, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V. Groenewoudseweg 1, Eindhoven (NL)

(21) Appl. No.: 10/547,091

(22) PCT Filed: Nov. 24, 2003
(86) PCT No.: PCT/IB03/05377

§ 371 Date: Sep. 9, 2006

Related U.S. Application Data
(60) Provisional application No. 60/430,879, filed on Dec. 4, 2002.

(51) Int. Cl. H04N 7/10; G06F 3/00; G06F 13/00; H04N 7/025; H04N 5/445

(52) U.S. Cl. 725/46; 725/34; 725/35

(57) ABSTRACT

A method for recommending a video content to a viewer. The method including the steps of: determining a user profile of the viewer, the user profile indicating the viewing preferences of the viewer, providing a plurality of user profiles; comparing the user profile of the viewer to each of the plurality of user profiles to determine if each of the plurality of user profiles contains at least one common characteristic with the user profile of the viewer; and determining a recommendation for the video content based on the plurality of user profiles, wherein user profiles having the at least one common characteristic are assigned a greater recommendation weight than user profiles not having the at least one common characteristic.

The present invention relates generally to recommendation of television shows and other broadcasts, and more particularly, to personal video recorders (PVR's) having television recommenders for generating recommendation scores for the shows based on user profiles of users who have previously viewed the show and/or with similar viewing habits.

Presently, recommenders, such as personal video recorders (PVR's) classify video content, such as television shows based on several categories (genre, actors, time shown etc), and create user profiles in the space of these categories (e.g., viewer likes sci-fi shown between 8-9 pm, he also likes sitcoms between 7-8 pm, he likes shows with Jerry Seinfeld, Arnold Schwarzeneger etc.). When a new show is aired on TV, the recommender looks into the show's categories and determines how close the show is to the specific user profile. Based on some criteria like distance, rule matching, etc., the recommender does or does not recommend the show to the viewer. The recommendation can be a simple “thumbs-up” or “thumbs-down” or a recommendation score. Such methods for making a recommendation are well known in the art, such as that disclosed in co-pending U.S. patent application Ser. No. 09/466,406, filed Dec. 17, 1999 entitled Method and Apparatus for Recommending Television Programming using Decision Trees, the contents of which are incorporated herein by reference. If there is a sitcom between 7-8 pm, the recommender will generally recommend it to the viewer, because the viewer's user profile indicates he/she likes sitcoms at that hour. However, that may not be a good recommendation, because the viewer may like “Seinfeld” broadcast between 7-8 pm, but not “Friends” broadcast at the same time.

There are other types of recommenders known in the art which are referred to as collaborative recommenders, such as that disclosed in co-pending U.S. patent application Ser. No. 09/953,385, filed Sep. 10, 2001 and entitled Four-Way Recommendation Method and System Including Collaborative Filtering, the contents of which are incorporated herein by reference. Such collaborative recommenders obtain the response of the other users, and then recommend a show to the viewer. However, while such collaborative recommenders have there advantages, the response is the same for all users, which can be a flaw.

Therefore it is an object of the present invention to provide a method and apparatus for recommending a previously shown video content to a user that overcomes the disadvantages of the prior art.

Accordingly, a method for recommending a video content to a viewer is provided. The method comprising: determining a user profile of the viewer, the user profile indicating the viewing preferences of the viewer; providing a plurality of user profiles; comparing the user profile of the viewer to each of the plurality of user profiles to determine if each of the plurality of user profiles contains at least one common characteristic with the user profile of the viewer; and determining a recommendation for the video content based on the plurality of user profiles, wherein user profiles having the at least one common characteristic are assigned a greater recommendation weight than user profiles not having the at least one common characteristic.

Preferably, the providing comprises transmitting the plurality of user profiles from a remote location to the viewer.

In a first implementation of the method, the video content has been previously broadcast and the at least one common characteristic comprises whether each of the plurality of user profiles corresponds to a user who has viewed the previously broadcast video content. Another of the at least one common characteristic is preferably a degree of similarity between the user profile of the user and each of the plurality of user profiles. In which case the determining preferably comprises assigning a numerical recommendation weight corresponding to the degree of similarity for each of the plurality of user profiles. Alternatively, the determining comprises assigning a greater recommendation weight to the plurality of user profiles having a degree of similarity greater than a predetermined threshold.

In a second implementation, the at least one common characteristic is a degree of similarity between the user profile of the user and each of the plurality of user profiles.

Also provided is an apparatus for making a recommendation of a video content to a viewer. The apparatus comprising: means for determining a user profile of the viewer, the user profile indicating the viewing preferences of the viewer; communication means for receiving a plurality of user profiles; processing means for comparing the user profile of the viewer to each of the plurality of user profiles to determine if each of the plurality of user profiles contains at least one common characteristic with the user profile; and a recommender for determining a recommendation for the video content based on the plurality of user profiles, wherein user profiles having the at least one common characteristic are assigned a greater recommendation weight than user profiles not having the at least one common characteristic.

Preferably, the communication means comprises a modem for transmitting the plurality of user profiles from a remote location to the viewer.

In a first implementation of the apparatus, the video content has been previously broadcast and the at least one common characteristic comprises whether each of the plurality of user profiles corresponds to a user who has viewed the previously broadcast video content. Another of the at least one common characteristic is a degree of similarity between the user profile of the user and each of the plurality of user profiles. In which case, the recommender preferably assigns a numerical recommendation weight corresponding to the degree of similarity for each of the plurality of user profiles. Alternatively, the recommender assigns a greater recommendation weight to the plurality of user profiles having a degree of similarity greater than a predetermined threshold.

Alternatively, the at least one common characteristic is a degree of similarity between the user profile of the user and each of the plurality of user profiles.

Still further provided is a method for recommending a video content previously broadcast to a viewer. The method comprising: determining a user profile of the viewer, the user profile indicating the viewing preferences of the viewer, providing a plurality of user profiles of volunteer users to a remote station, each of the volunteer users having viewed the previously broadcast video content; at the remote station, comparing the user profile of the viewer to each of the plurality of user profiles to determine if each of the plurality of user profiles contains a degree of similarity with the user profile of the viewer; at the remote station, determining a recommendation for the video content based on the plurality of user profiles, wherein user profiles having a predetermined degree of similarity are assigned a greater recommendation weight than user profiles not having the predetermined degree of similarity; and transmitting the recommendation to the viewer.

Also provided are a computer program product for carrying out the methods of the present invention and a program storage device for the storage of the computer program product therein.

These and other features, aspects, and advantages of the apparatus and methods of the present invention will become better understood with regard to the following description, appended claims, and accompanying drawings where:

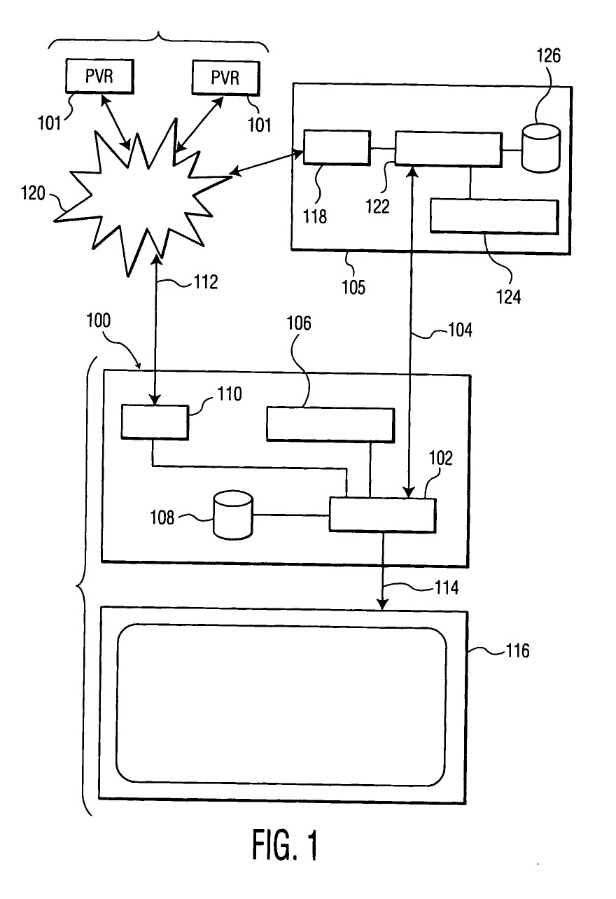

FIG. 1 illustrates a schematic view of a preferred implementation of an apparatus for carrying out the methods of the present invention.

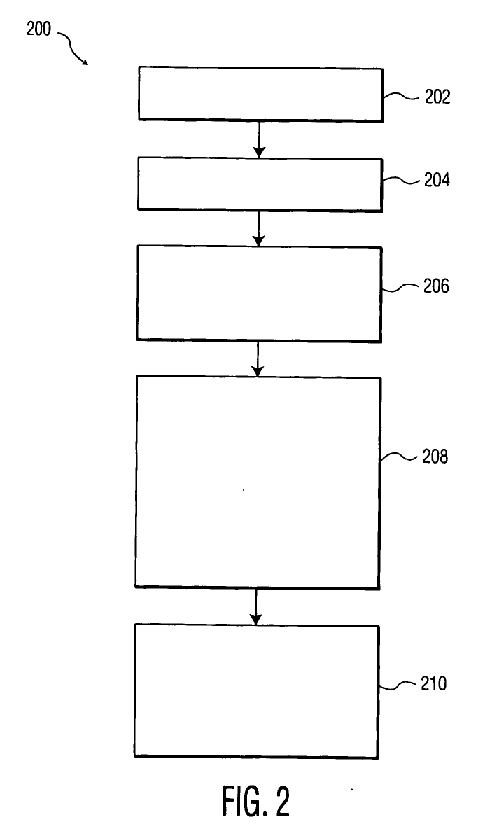

FIG. 2 illustrates a flow chart of a preferred implementation of the methods of the present invention.

Although this invention is applicable to numerous and various types of video content, it has been found particularly useful in the environment of broadcast television shows. Therefore, without limiting the applicability of the invention to television shows, the invention will be described in such environment.

Referring now to FIG. 1, an apparatus for making a recommendation of a video content to a viewer is shown therein, the apparatus generally referred to by reference numeral 100. The apparatus 100 is generally a recommender system, such as a Personal Video Recorder (PVR). Such PVR's are well known in the art. In general, PVR's recommend video content, such as television shows, based on a user profile of the viewer stored in memory. The user profile indicates viewing preferences of the viewer based on the viewing history of a viewer and/or manual input by the viewer.

The apparatus 100 comprises a processor 102 for receiving a video content signal 104 from a remote station 105, such as a cable provider, television broadcast signal, satellite transmission, or cellular transmission. The processor 102 also controls the operation of a recommender 106, storage device 108, and communication means 110. The recommender 106 is configured to provide a recommendation and/or a user profile as described above, and as is known in the art. The storage device 108 is preferably a hard drive for storing video content received from the video content signal 104, a user profile, and/or instructions for carrying out the operation of the processor 102, recommender 106 and/or communication means 110. The storage device 108, although shown as a single device can be implemented in a number of storage devices.

The communication means 110 is preferably a modem, such as a cable or telephone modem that receives a communication signal 112 from the remote station 105 or another third party. As will be discussed below, the communication signal 112 can contain information indicative of a plurality of user profiles to be used in making a recommendation for a particular video content, such as a television show. Although, the video content signal 104 and communication signal 112 are shown as separate signals, they can also be provided in a single signal and multiplexed therefrom. For example, a cable provider can provide the video content signal and communication signal in the same signal from a coaxial cable (not shown). The apparatus 100 supplies an output signal 114 to a display means, such as a television monitor 116, for viewing the video content signal, video content stored on the storage device 108, or a user interface for providing instructions to the apparatus 100. The instructions are preferably input to the apparatus with a remote control device (not shown) as is known in the art. For purposes of this disclosure, “viewer” shall mean that person for whom the video content is being recommended and “users” shall mean those persons corresponding to the plurality of user profiles transmitted to the apparatus 100.

A first embodiment of a method for recommending a video content to a viewer will now be described with reference to FIGS. 1 and 2, the method generally referred to by-reference numeral 200. At step 202, a user profile of the viewer is determined using the recommender 106 and as is known in the art. As discussed above, the user profile of the viewer indicates the viewing preferences of the viewer that could be based on the input of the viewer (e.g., voting) or based on the viewer's viewing history. At step 204 a plurality of user profiles are provided to the apparatus 100. The plurality of user profiles are preferably provided by a third party at a remote location 105. such as the video content provider via the communication signal 112 or alternatively, as part of the video content signal 104. Typically, the video content provider has a database of user profiles, the entirety or a sample of which, can be transmitted to the apparatus 100. Alternatively, the third party 105 can access a sampling of PVR's, or other like devices, and retrieve a corresponding user profile from each PVR accessed as is disclosed in co-pending U.S. application No. ______ entitled Prediction Of Ratings For Shows Not Yet Shown (attorney Docket 702926 (15921)), the contents of which are incorporated herein by reference. The user profiles accessed from the sampling of PVR's are then transmitted to the apparatus 100 via the communication signal 112 or multiplexed into the video control signal 104.

At step 206, the processor 102 compares the user profile of the viewer to each of the plurality of user profiles transmitted to the apparatus 100. At step 208 it is determined whether each of the plurality of user profiles contains at least one common characteristic with the user profile of the viewer. At step 210, the recommender 106 determines a recommendation for the video content based on the plurality of user profiles, wherein user profiles having the at least one common characteristic are assigned a greater recommendation weight than user profiles not having the at least one common characteristic.

In a first implementation of the methods of the first embodiment, the video content has been previously broadcast and the at least one common characteristic comprises whether each of the plurality of user profiles corresponds to a user who has viewed the previously broadcast video content. The user profiles corresponding to a user who has actually viewed the video content for which a recommendation is to be made are preferably assigned a greater weight than those user profiles that correspond to a user who has not viewed the video content.

In a simplest implementation, the user profiles corresponding to a user who has actually viewed the video content are assigned a weight of 1 and the user profiles that correspond to a user who has not viewed the video content are assigned a weight of zero. Thus, only the user profiles corresponding to a user who has actually viewed the video content will be used in determining the recommendation. Those skilled in the art will appreciate that more complicated weighing algorithms can be used to assign weights to each of the plurality of user profiles. For example, more than one common characteristic can be used to assign the weights to the user profiles, only one of which can be whether a user corresponding to the user profile has actually viewed the video content.

An example of another common characteristic, which can be used in combination with other common characteristics or by itself, is a degree of similarity between the user profile of the user and each of the plurality of user profiles. In such a situation, the comparing of the user profile of the viewer to each of the plurality of user profiles comprises computing a distance using a distance metrics or a degree of similarity between the user profile of the viewer and each of the plurality of user profiles. Algorithms for measuring similarities are well known in the art, such as a histogram intersection.

If a distance is measured, a recommendation weight is assigned to each of the plurality of user profiles in inverse proportion to the distance from the user profile of the viewer. If the distance is great (the user profile of the viewer and one of the plurality of user profiles are not very similar) then the assigned weight will be small, and vice versa, if the distance is small (the user profile of the viewer and one of the plurality of user profiles are very similar) the assigned weight will be high. If a similarity is measured, the recommendation weight is in proportion to the similarity (if the similarity is great, the recommendation will be high, if the similarity is low, the recommendation will be low).

One way to assign weights to the plurality of user profiles is to assign a numerical recommendation weight corresponding to the degree of similarity for each of the plurality of user profiles. Alternatively, a greater recommendation weight is assigned to the plurality of user profiles having a degree of similarity greater than a predetermined threshold (the assigned weight is 1 if the degree of similarity is greater than the predetermined threshold and 0 if less than the predetermined threshold).

### EXAMPLE

In a preferred implementation, the weights are assigned to each of the plurality of user profiles according to whether a user actually viewed the video content and the degree of similarity to the user profile of the viewer. If the third party is a cable provider who has the user profiles, and also collects votes form the certain number (N) of users about the video content that has been previously broadcast. The user profiles and corresponding votes are transmitted to the apparatus 100 and a recommendation is made to the viewer based on the user profiles and the responses made by the users regarding the video content.

Let the user profile of the viewer be (p_{A}) and the plurality of user profiles corresponding to the users who voted for the video content be (p₁, p₂, . . . , p_{N}). Let rₖ denote the recommendation score that user k has assigned to the show. The degree of similarity is determined by computing distances d, =d(p_{A}, pᵢ), I=1, 2, . . . ,N, using any distance matrix, such as a histogram intersection, which is known in the art. Next, weights wᵢ, are determined based on the distance between the viewer and the users. Typically, the users which are closer to the viewer will be assigned higher weights than those that are far apart. The distance weights are then adjusted by a factor of rᵢ. The recommendation for the video content can then be computed as:

$$R = \frac{{\sum }_{i = l}^{N} {w}_{i} {r}_{i}}{{\sum }_{i = l}^{N} {w}_{i}} \qquad ( 1 )$$

Although, the methods of the present invention have been described with the recommendation being made at the viewer's apparatus 100, those skilled in the art will appreciate that the recommendation can alternatively be made at the third party, in which case the viewer's user profile is transmitted to the third party and a recommendation is transmitted back to the viewer based on the plurality of user profiles stored at the third party.

Referring back to FIG. 1, a second, or alternative embodiment, of the methods of the present invention will now be described in which the recommendation is determined at the third party 105 and transmitted to the apparatus 100 via line 112 or 104. The remote station 105. for instance a cable provider, offers an additional service to its subscribers, which is a recommendation system. The recommendation system has a set of volunteer users who provide feedback on one or more of the shows they watch, and cable provider builds their respective user profiles based on the feedback. The volunteer users have corresponding apparatus 101 similarly configured to that of apparatus 100. The volunteer users preferably provide their user profile to the cable provider 105 via a modem 110 and communication signal 112 similar to that shown in apparatus 100. The cable provider 105 receives the user profiles from the volunteer users via its own communication means 118, such as a modem, which operates over a telephone network 120. Other types of communication are obviously possible between the volunteer users, viewer, and the cable provider 105. In exchange for sharing their user profile with the cable provider, the cable provider 105 may offer the volunteer users compensation, such as a discount on their cable bill.

The user profiles of the volunteer users can be transmitted to the cable provider 105 from their corresponding apparatus 101 via a communication means or alternatively, the user profiles of the volunteer users can be built at the cable provider in two ways. First, the cable provider can monitor which shows each volunteer user watches and build a user profile from these shows. However, this may not be very precise, as the volunteer user may have his television 116 on without viewing it, or he/she may not like the show that was just viewed. It is therefore beneficial for the volunteer user to provide feedback on the shows he/she has viewed. The more feedback the volunteer user provides, the more precise his/her user profile will be.

The cable provider 105 can then recommend a previously watched video content to the viewer based on the user profile of the viewer and the plurality of user profiles from the volunteer users, similarly to that described above with regard to the first embodiment. However, in determining the recommendation, the cable provider 105 uses a processor 122 recommender 124 and storage device 126 internal to the cable provider 105. Again, the viewer's user profile can be transmitted to the cable provider 105 as discussed above with regard to the first embodiment or it can be built by the cable provider as discussed above. Preferably, the user profile of the viewer is also constructed using feedback sent to the cable provider 105.

Therefore, when video content, such as a television show, is broadcast and feedback is received from the volunteer users, the cable provider computes a recommendation for that broadcast for the viewer and will recommend that the viewer see or doesn't see the show at a later broadcast. Shows on cable are often broadcast many times within a short time span. Preferably, the viewer will pay the cable provider 105 or other third party for the recommendation service.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for recommending a video content to a viewer, the method comprising:
determining a user profile of the viewer, the user profile indicating the viewing preferences of the viewer;
providing a plurality of user profiles;
comparing the user profile of the viewer to each of the plurality of user profiles to determine if each of the plurality of user profiles contains at least one common characteristic with the user profile of the viewer; and
determining a recommendation for the video content based on the plurality of user profiles, wherein user profiles having the at least one common characteristic are assigned a greater recommendation weight than user profiles not having the at least one common characteristic.

2. The method of claim 1, wherein the video content has been previously broadcast and the at least one common characteristic comprises whether each of the plurality of user profiles corresponds to a user who has viewed the previously broadcast video content.

3. The method of claim 1, wherein the providing comprises transmitting the plurality of user profiles from a remote location (105) to the viewer.

4. The method of claim 2, wherein another of the at least one common characteristic is a degree of similarity between the user profile of the user and each of the plurality of user profiles.

5. The method of claim 4, wherein the determining comprises assigning a numerical recommendation weight corresponding to the degree of similarity for each of the plurality of user profiles.

6. The method of claim 4, wherein the determining comprises assigning a greater recommendation weight to the plurality of user profiles having a degree of similarity greater than a predetermined threshold.

7. The method of claim 1, wherein the at least one common characteristic is a degree of similarity between the user profile of the user and each of the plurality of user profiles.

8. An apparatus (100) for making a recommendation of a video content to a viewer, the apparatus comprising:
means (106) for determining a user profile of the viewer, the user profile indicating the viewing preferences of the viewer;
communication means (110) for receiving a plurality of user profiles;
processing means (102) for comparing the user profile of the viewer to each of the plurality of user profiles to determine if each of the plurality of user profiles contains at least one common characteristic with the user profile; and
a recommender (106) for determining a recommendation for the video content based on the plurality of user profiles, wherein user profiles having the at least one common characteristic are assigned a greater recommendation weight than user profiles not having the at least one common characteristic.

9. The apparatus of claim 8, wherein the video content has been previously broadcast and the at least one common characteristic comprises whether each of the plurality of user profiles corresponds to a user who has viewed the previously broadcast video content.

10. The apparatus of claim 8, wherein the communication means (110) comprises a modem for transmitting the plurality of user profiles from a remote location (105) to the viewer.

11. The apparatus of claim 9, wherein another of the at least one common characteristic is a degree of similarity between the user profile of the user and each of the plurality of user profiles.

12. The apparatus of claim 11, wherein the recommender (106) assigns a numerical recommendation weight corresponding to the degree of similarity for each of the plurality of user profiles.

13. The apparatus of claim 11, wherein the recommender (106) assigns a greater recommendation weight to the plurality of user profiles having a degree of similarity greater than a predetermined threshold.

14. The Apparatus of claim 8, wherein the at least one common characteristic is a degree of similarity between the user profile of the user and each of the plurality of user profiles.

15. A computer program product embodied in a computer-readable medium for recommending a video content to a viewer, the computer program product comprising:
computer readable program code means for determining a user profile of the viewer, the user profile indicating the viewing preferences of the viewer;
computer readable program code means for providing a plurality of user profiles;
computer readable program code means for comparing the user profile of the viewer to each of the plurality of user profiles to determine if each of the plurality of user profiles contains at least one common characteristic with the user profile of the viewer; and
computer readable program code means for determining a recommendation for the video content based on the plurality of user profiles, wherein user profiles having the at least one common characteristic are assigned a greater recommendation weight than user profiles not having the at least one common characteristic.

16. A program storage device readable by machine, tangibly embodying a program of instructions executable by the machine to perform method steps for recommending a video content to a viewer, the method comprising:
determining a user profile of the viewer, the user profile indicating the viewing preferences of the viewer;
providing a plurality of user profiles;
comparing the user profile of the viewer to each of the plurality of user profiles to determine if each of the plurality of user profiles contains at least one common characteristic with the user profile of the viewer; and
determining a recommendation for the video content based on the plurality of user profiles, wherein user profiles having the at least one common characteristic are assigned a greater recommendation weight than user profiles not having the at least one common characteristic.

17. A method for recommending a video content previously broadcast to a viewer, the method comprising:
determining a user profile of the viewer, the user profile indicating the viewing preferences of the viewer;
providing a plurality of user profiles of volunteer users to a remote station (105), each of the volunteer users having viewed the previously broadcast video content;
at the remote station (105), comparing the user profile of the viewer to each of the plurality of user profiles to determine if each of the plurality of user profiles contains a degree of similarity with the user profile of the viewer;
at the remote station (105), determining a recommendation for the video content based on the plurality of user profiles, wherein user profiles having a predetermined degree of similarity are assigned a greater recommendation weight than user profiles not having the predetermined degree of similarity; and
transmitting the recommendation to the viewer.
